(19) United States
(12) Patent Application Publication
(10) Pub. No.: US 2019/0129475 A1
(43) Pub. Date: May 2, 2019

(54) ELECTRONIC DEVICE

(71) Applicants: Tzu-Chien Lai, Taipei City (TW); Shih-Yao Lin, Taipei City (TW); Tung-Ching Lin, Taipei City (TW)

(72) Inventors: Tzu-Chien Lai, Taipei City (TW); Shih-Yao Lin, Taipei City (TW); Tung-Ching Lin, Taipei City (TW)

(73) Assignee: COMPAL ELECTRONICS, INC., Taipei City (TW)

(21) Appl. No.: 16/177,411

(22) Filed: Oct. 31, 2018

Related U.S. Application Data
(60) Provisional application No. 62/579,903, filed on Nov. 1, 2017.

(51) Int. Cl. G06F 1/16; E05D 7/00; E05D 11/06

(52) U.S. Cl. CPC G06F 1/1681; E05D 7/00; E05Y 2900/606; G06F 1/1616; G06F 1/166; E05D 11/06

(57) ABSTRACT

An electronic device includes a first body, a second body, a hinge structure, a pivot bracket, and a third body. The hinge structure is pivotally connected to the first body and the second body, and the second body is adapted to rotate along an axis relative to the first body. The pivot bracket includes a pivot portion and a fixing portion, wherein the pivot portion is pivoted to the hinge structure. The third body is fixed to the fixing portion of the pivot bracket, so that the third body is adapted to rotate along the axis center relative to the first body.

### CROSS-REFERENCE TO RELATED APPLICATION

This application claims the priority benefit of U.S. provisional application Ser. No. 62/579,903, filed on Nov. 1, 2017. The entirety of the above-mentioned patent application is hereby incorporated by reference herein and made a part of this specification.

### TECHNICAL FIELD

The disclosure relates to an electronic device; more particularly, the disclosure relates to an electronic device with three bodies that are pivotally rotatable relative to one another.

### DESCRIPTION OF RELATED ART

With the advancement of science and technology, electronic devices (e.g., notebook computers) have been widely used. Most existing notebook computers have two bodies, wherein the upper body with a screen may be unfolded relative to the lower body to a normal working position. However, due to the increasing functions of the electronic devices, the electronic devices can provide the user with not only the functions of general work processing functions but also other functions such as audio and video entertainment to the user, such that the electronic devices may require more bodies. Besides, when the electronic devices provide users with different functions, if the relative positions between or among the bodies of the electronic devices may be correspondingly adjusted, the users' perception and experience can be enhanced, and the improved convenience of use may be guaranteed.

### SUMMARY

The disclosure provides an electronic device with three bodies that are pivotally rotatable relative to one another.

In an embodiment, an electronic device includes a first body, a second body, a hinge structure, a pivot bracket, and a third body. The hinge structure is pivoted to the first body and the second body, so as to adapt the second body to rotate along an axis relative to the first body. The pivot bracket includes a pivot portion and a fixing portion, wherein the pivot portion is pivoted to the hinge structure. The third body is fixed to the fixing portion of the pivot bracket, so that the third body is adapted to rotate along the axis relative to the first body.

According to an embodiment, the first body includes a first surface and a second surface opposite to each other. The first body is adapted to be turned to a deployed position from a closed position at which the first surface of the first body abutting against the second body and the third body. The second body includes a first side away from the hinge structure. When the first body is located at the deployed position, the second body is adapted to be turned relative to the first body, such that the first side of the second body approaches the second surface of the first body, and the third body is adapted to maintain a relative position between the third body and the first body.

According to an embodiment, when a third rotation angle is between the first body and the second body, and the third body and the second body are in an unfolded flat configuration, the electronic device is located at a first working position, wherein when the first body is in an unfolded flat configuration with respect to the second body and the third body, the electronic device is located at a deployed position, wherein when a first rotation angle is between the first body and the second body, and a second rotation angle is between the first body and the third body, the electronic device is located at a second working position, and when the first body is closed with the second body and the third body, the electronic device is located at a closed position.

According to an embodiment, a first rotation angle at which the second body is adapted to rotate relative to the first body is greater than a second rotation angle at which the third body is adapted to rotate relative to the first body.

According to an embodiment, a maximum value of the first rotation angle is from 160 degrees to 290 degrees, and a maximum value of the second rotation angle is from 135 degrees to 160 degrees.

According to an embodiment, a maximum value of the first rotation angle is from 160 degrees to 290 degrees, and a maximum value of the second rotation angle is from 0 degree to 135 degrees.

According to an embodiment, the hinge structure includes a first stopping surface located on a rotational track of the pivot bracket to limit a rotational range of the pivot bracket relative to the hinge structure.

According to an embodiment, the hinge structure includes a first rotating shaft, a second rotating shaft pivotally connected to the first rotating shaft, and a first position-limiting ring sleeve, the first rotating shaft is fixed to the first body, the second rotating shaft is fixed to the second body, the first position-limiting ring sleeve is sleeved on the first rotating shaft or the second rotating shaft, the pivot portion of the pivot bracket is pivoted to the first rotating shaft or the second rotating shaft sleeved by the first position-limiting ring sleeve, and the first stopping surface is formed on the first position-limiting ring sleeve.

According to an embodiment, the hinge structure includes a second position-limiting ring sleeve, the first position-limiting ring sleeve is sleeved on one of the first rotating shaft and the second rotating shaft, the second position-limiting ring sleeve is sleeved on the other of the first rotating shaft and the second rotating shaft, a second stopping surface of the hinge structure is formed on the second position-limiting ring sleeve, and the second stopping surface is located on the rotational track of the pivot portion of the pivot bracket.

According to an embodiment, the second body includes a second side close to the hinge structure, the second body has a recess recessed into the second side, and when the second body and the third body are in the same plane, the third body is located in the recess.

According to an embodiment, an outer contour of the third body and an inner contour of the recess of the second body are conformal.

According to an embodiment, the first body includes a screen, the second body includes an input module, and the third body includes a speaker, a sound collection unit, or a sub-screen.

In an embodiment, an electronic device includes a first body, a second body, and a third body. The first body has a display module. The second body is pivotally connected to the first body. The third body is located between the first body and the second body. When a first rotation angle is between the first body and the second body, a second rotation angle is between the first body and the third body, and the first rotation angle is greater than the second rotation angle, the second body and the third body together support the first body.

According to an embodiment, the third body is pivotally connected to the first body or the second body.

According to an embodiment, an axis of rotation between the first body and the second body and an axis of rotation between the third body and the first body or the second body are coaxial.

According to an embodiment, when the first rotation angle is greater than 180 degrees, the third body rotates along with the first body without rotating with the second body.

According to an embodiment, when the first rotation angle is less than 180 degrees, the third body rotates along with the second body without rotating with the first body.

According to an embodiment, the third body is slidably disposed on the first body or the second body.

According to an embodiment, the electronic device further includes a hinge structure pivotally connected to the first body and the second body to adapt the second body to rotate along an axis relative to the first body, and the electronic device further includes a pivot bracket including a pivot portion and a fixing portion. The pivot portion is pivoted to the hinge structure.

According to an embodiment, the hinge structure includes a first stopping surface located on a rotational track of the pivot portion of the pivot bracket to limit a rotational range of the pivot bracket relative to the hinge structure.

According to an embodiment, the hinge structure includes a first rotating shaft, a second rotating shaft pivotally connected to the first rotating shaft, and a first position-limiting ring sleeve, the first rotating shaft is fixed to the first body, the second rotating shaft is fixed to the second body, the first position-limiting ring sleeve is sleeved on the first rotating shaft or the second rotating shaft, the pivot portion of the pivot bracket is pivoted to the first rotating shaft or the second rotating shaft sleeved by the first position-limiting ring sleeve, and the first stopping surface is formed on the first position-limiting ring sleeve.

According to an embodiment, the hinge structure includes a second position-limiting ring sleeve, the first position-limiting ring sleeve is sleeved on one of the first rotating shaft and the second rotating shaft, the second position-limiting ring sleeve is sleeved on the other of the first rotating shaft and the second rotating shaft, a second stopping surface of the hinge structure is formed on the second position-limiting ring sleeve, and the second stopping surface is located on the rotational track of the pivot portion of the pivot bracket.

According to an embodiment, the second body includes a second side close to the hinge structure, and the second body has a recess recessed into the second side. When the second body and the third body are in the same plane, the third body is located in the recess.

According to an embodiment, an outer contour of the third body and an inner contour of the recess of the second body are conformal.

According to an embodiment, the second body includes an input module, and the third body includes a speaker, a sound collection unit, or a sub-screen.

In view of the above, the electronic device is equipped with three bodies, so as to satisfy diverse needs of users. Besides, the electronic device provided herein is pivotally connected to the first body and the second body by the hinge structure, so as to adapt the second body to rotate relative to the first body. In addition, the pivot portion of the pivot bracket is pivoted to the hinge structure, and the third body is fixed to the fixing portion of the pivot bracket to adapt the third body to rotate relative to the first body. As such, the first body, the second body, and the third body may rotate relative to one another along the same axis, and the user may adjust the positions of the three bodies according to actual needs, so as to enhance the user's experience while the electronic device performs different functions.

To make the above features and advantages provided in one or more of the embodiments of the invention more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles described herein.

FIG. 1 is a schematic view of an electronic device at a closed position according to an embodiment of the invention.

FIG. 2 is a schematic view illustrating the electronic device depicted in FIG. 1 is at a first working position.

FIG. 3 is a schematic view illustrating the electronic device depicted in FIG. 1 is at a deployed position.

FIG. 4 is a schematic view illustrating the electronic device depicted in FIG. 1 is at a second working position.

FIG. 5 is a schematic exploded view illustrating the electronic device depicted in FIG. 1 is at different view angles.

FIG. 6 is a schematic partially-enlarged view of FIG. 5.

FIG. 7A and FIG. 7B are schematic views illustrating the hinge structure and the pivot bracket of the electronic device depicted in FIG. 1 are at different view angles.

FIG. 8 is a schematic view illustrating a partial horizontal cross-section of the electronic device at the deployed position depicted in FIG. 3.

FIG. 9 is a schematic view illustrating a partial vertical cross-section of the electronic device depicted in FIG. 1 is at the closed position.

FIG. 10 is a schematic view illustrating a partial vertical cross-section of the electronic device at the deployed position depicted in FIG. 3.

### DESCRIPTION OF THE EMBODIMENTS

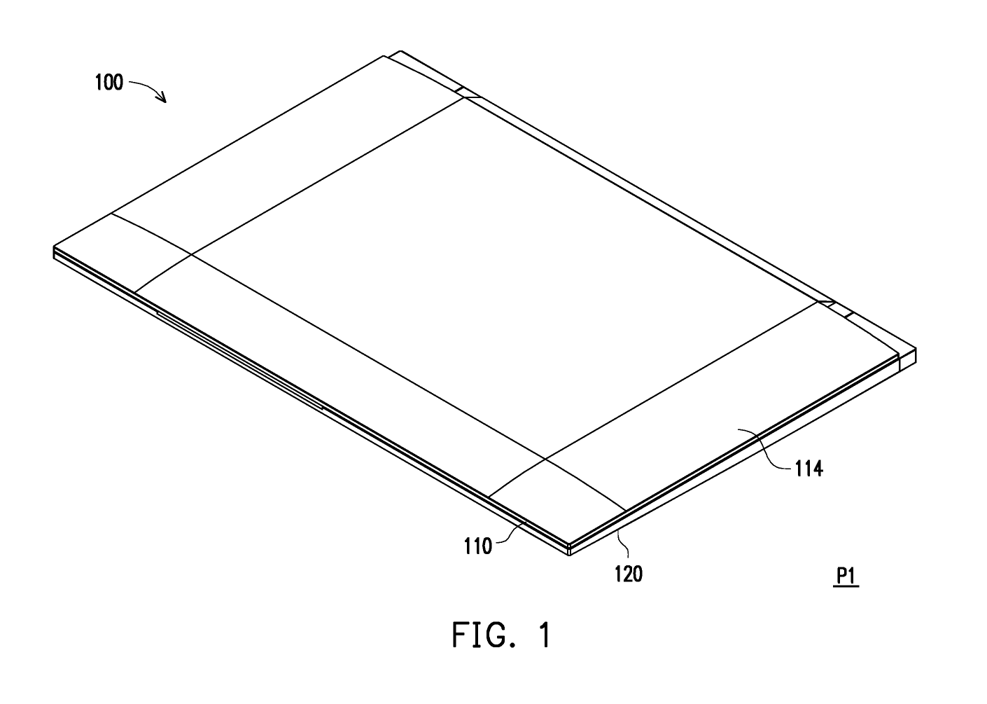

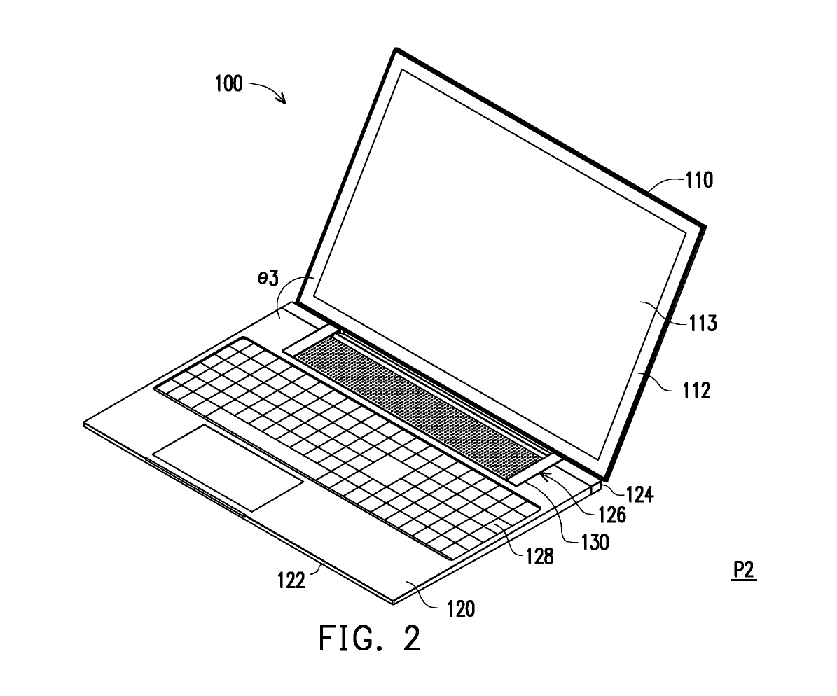

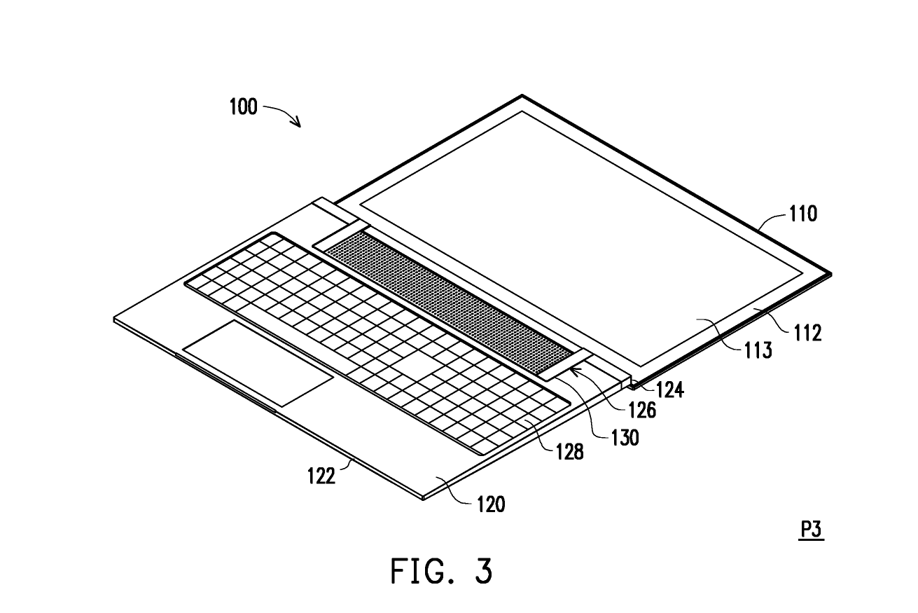

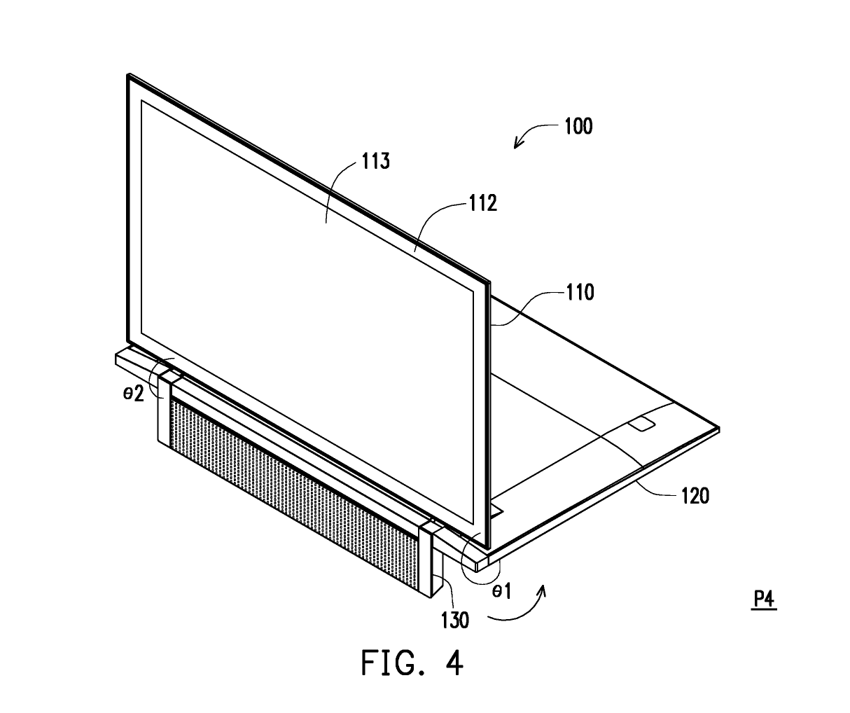

FIG. 1 is a schematic view of an electronic device according to an embodiment of the invention. FIG. 2 is a schematic view illustrating the electronic device depicted in FIG. 1 is at a first working position. FIG. 3 is a schematic view illustrating the electronic device depicted in FIG. 1 is at a deployed position. FIG. 4 is a schematic view illustrating the electronic device depicted in FIG. 1 is at a second working position. With reference to FIG. 1 to FIG. 4, the electronic device 100 in this embodiment is a notebook computer, for instance, while the electronic device 100 in other embodiments may also be a clamshell mobile phone or any other electronic device 100. The type of the electronic device 100 is not limited thereto. In the present embodiment, the electronic device 100 includes a first body 110, a second body 120, and a third body 130. According to the present embodiment, the first body 110 includes a screen 113, the second body 120 includes an input module 128, and the third body 130 includes a speaker, a sound collection unit, or a sub-screen. The input module 128 includes a keyboard or/and a touch pad, for instance. Certainly, the types of the first body 110, the second body 120, the third body 130, and the input module 128 are not limited herein. In other embodiments, the third body 130 may also include a distance sensor, a microphone, a camera lens, or other electronic components.

As shown in FIG. 1 to FIG. 4, in the present embodiment, the first body 110, the second body 120, and the third body 130 may rotate relative to one another along the same axis. Hence, a user is able to adjust the first body 110, the second body 120, and the third body 130 to proper relative positions to comply with different requirements of use. Particularly, in the present embodiment, the first body 110 includes a first surface 112 (for example, an inner surface, shown in FIG. 2) and a second surface 114 (for example, an outer surface, shown in FIG. 1) opposite to each other. The first body 110 is adapted to be turned from a closed position P1 as shown in FIG. 1 (i.e., a position at which the first surface 112 of the first body 110 abutting against the second body 120 and the third body 130) to a first working position P2 shown in FIG. 2. When the electronic device 100 is at the first working position P2, the user may input information through the input module 128 of the second body 120 as if the user operates the normal notebook computer, and may watch from the screen 113 of the first body 110. Certainly, in other embodiments, the third body 130 may be slidably disposed on the first body 110 or the second body 120, and the configuration relationship is not limited thereto.

In the present embodiment, the first body 110 of the electronic device 100 may also be turned from the first working position P2 shown in FIG. 2 to a deployed position P3 shown in FIG. 3 with respect to the second body 120 and the third body 130. According to the present embodiment, when the electronic device 100 is located at the deployed position P3, the first body 110, the second body 120, and the third body 130 may be integrally placed and spread flat on the desktop. An included angle between the first body 110 and the second body 120 or between the first body 110 and the third body 130 is, for example, 180 degrees, but the deployed position P3 of the electronic device 100 is not limited thereto.

As shown in FIG. 3, the second body 120 provided in the embodiment includes a first side 122 and a second side 124. When the first body 110 is located at the deployed position P3, the first side 122 of the second body 120 is away from the first body 110, and the second side 124 of the second body 120 is near the first body 110. The second body 120 has a recess 126 recessed into the second side 124. When the second body 120 and the third body 130 are in the same plane, the third body 130 is located in the recess 126, and an outer contour of the third body 130 and an inner contour of the recess 126 of the second body 120 are conformal. In the above-mentioned design, when the first body 110 is unfolded, and when the second body 120 and the third body 130 are in the same plane, the second body 120 and the third body 130 are intact in appearance and appear to be one integral body.

Besides, in the present embodiment, when the electronic device 100 is at the position shown in FIG. 3, the second body 120 is adapted to be flipped relative to the first body 110 and the third body 130, so that the first side 122 of the second body 120 approaches the second surface 114 of the first body 110, and that the third body 130 is adapted to maintain the relative position between the first body 110 and the third body 130 and flipped to a second working position P4 as shown in FIG. 4. As shown in FIG. 4, when the electronic device 100 is at the second working position P4, the second body 120 is flipped over to the rear of the first body 110 and the third body 130, and the second body 120 and the third body 130 together serve as a supporting base. The screen 113 of the first body 110 and the speaker of the third body 130 face forward and can provide the user with the improved watching and listening experience.

That is to say, in the present embodiment, the first body 110 is closed with the second body 120 and the third body 130 and the electronic device 100 is at the closed position P1. When a third rotation angle θ3 (shown in FIG. 2) is between the first body 110 and the second body 120, and the third body 130 and the second body 120 are in an unfolded flat configuration, the electronic device 100 is located at the first working position P2. When the first body 110 is in an unfolded flat configuration with respect to the second body 120 and the third body 130, the electronic device 100 is located at the deployed position P3. When a first rotation angle θ1 is between the first body 110 and the second body 120, and a second rotation angle θ2 is between the first body 110 and the third body 130, the electronic device 100 is located at the second working position P4.

As shown in FIG. 4, in the present embodiments, the first rotation angle θ1 at which the second body 120 is adapted to rotate relative to the first body 110 is greater than the second rotation angle θ2 at which the third body 130 is adapted to rotate relative to the first body 110. When the first rotation angle θ1 is greater than the second rotation angle θ2, the second body 120 and the third body 130 together support the first body 110. In an embodiment, the maximum value of the first rotation angle θ1 is from 160 degrees to 290 degrees, and the maximum value of the second rotation angle θ2 is from 135 degrees to 200 degrees. In another embodiment, the maximum value of the first rotation angle θ1 is from 160 degrees to 290 degrees, and the maximum value of the second rotation angle θ2 is from 0 degree to 135 degrees. In another embodiment, the maximum value of the first rotation angle θ1 is from 250 degrees to 290 degrees, and the maximum value of the second rotation angle θ2 is from 160 degrees to 200 degrees. For instance, according to the present embodiment, the maximum value of the first rotation angle θ1 is 270 degrees, and the maximum value of the second rotation angle θ2 is 180 degrees. That is, the first rotation angle θ1 is from 0 degree to 270 degrees, and the second rotation angle θ2 is from 0 degree to 180 degrees. Certainly, the relationship among the rotation angles of the first body 110, the second body 120, and the third body 130 is not limited thereto. In other embodiments, the first rotation angle at which the second body 120 rotates relative to the first body 110 may be equal to or smaller than the second rotation angle at which the third body 130 rotates relative to the first body 110, which can provide another working mode.

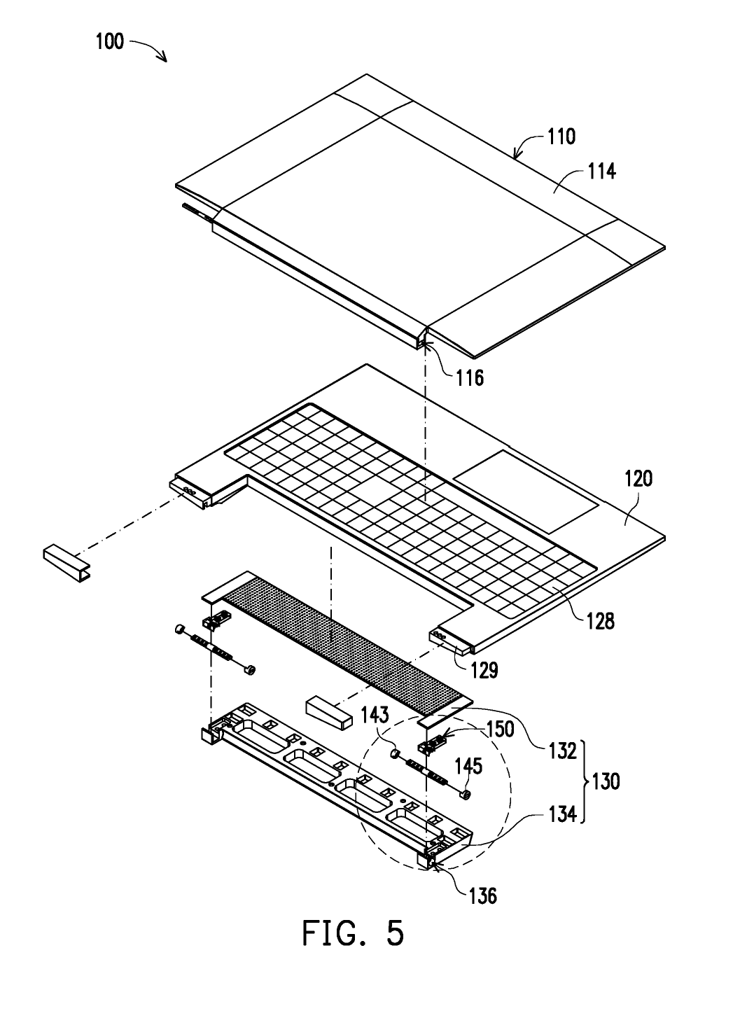

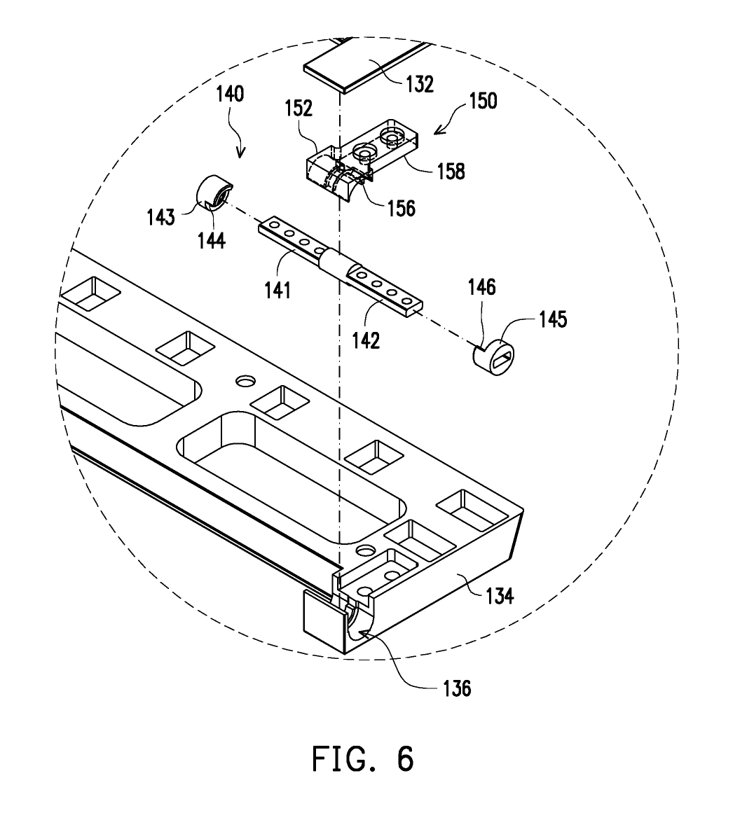

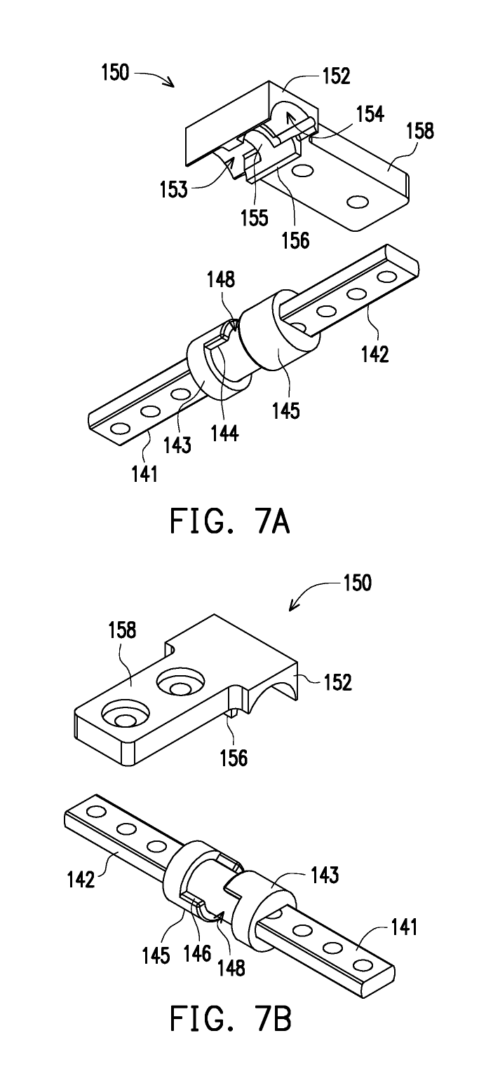

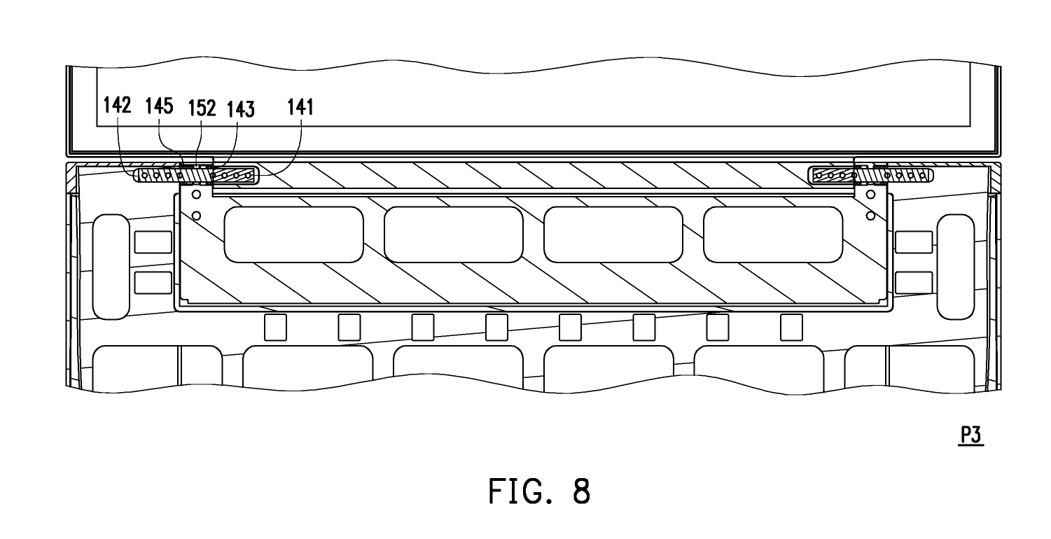

The detailed structure of the electronic device 100 (depicted in FIG. 1) which allows the first body 110, the second body 120, and the third body 130 to rotate relative to one another is elaborated hereinafter. FIG. 5 is a schematic exploded view illustrating the electronic device depicted in FIG. 1 is at different view angles. FIG. 6 is a schematic partially-enlarged view of FIG. 5. FIG. 7A and FIG. 7B are schematic views illustrating the hinge structure and the pivot bracket of the electronic device depicted in FIG. 1 are at different view angles. FIG. 8 is a schematic view illustrating a partial horizontal cross-section of the electronic device at the deployed position depicted in FIG. 3.

With reference to FIG. 5 to FIG. 8, the electronic device 100 provided in the embodiment further includes a hinge structure 140 (shown in FIG. 6) and a pivot bracket 150. The hinge structure 140 is pivotally connected to the first body 110 and the second body 120, so as to adapt the second body 120 to rotate relative to the first body 110. As shown in FIG. 6, the hinge structure 140 provided in the embodiment includes a first rotating shaft 141 and a second rotating shaft 142 pivotally connected to the first rotating shaft 141. In this embodiment, the first rotating shaft 141 extends into a first receiving groove 116 (shown in FIG. 5) of the first body 110 and is fixed to the first body 110, and the second rotating shaft 142 is fixed to a fixing section 129 (shown in FIG. 5) of the second body 120. Thereby, the second body 120 is adapted to rotate relative to the first body 110 along the axis of the first rotating shaft 141 and the second rotating shaft 142.

As shown in FIG. 6, the pivot bracket 150 provided in the embodiment includes a pivot portion 152 and a fixing portion 158. The pivot portion 152 is pivoted to the second rotating shaft 142 of the hinge structure 140 and may rotate relative to the second rotating shaft 142. In the present embodiment, the third body 130 includes an upper casing 132 and a lower casing 134. The pivot bracket 150 is located between the upper casing 132 and the lower casing 134. The pivot portion 152 of the pivot bracket 150 and a portion of the second rotating shaft 142 are rotatably located in a second receiving groove 136 of the lower casing 134. The fixing portion 158 of the pivot bracket 150 is fixed to the lower casing 134 of the third body 130. Hence, the third body 130 is adapted to rotate relative to the second body 120 through the pivot bracket 150. In addition, the second body 120 may rotate relative to the first body 110 and the third body 130 may also rotate relative to the first body 110, so that the first body 110, the second body 120, and the third body 130 may rotate relative to one another.

It is worth mentioning that the pivot portion 152 of the pivot bracket 150 is pivotally connected to the second rotating shaft 142 in this embodiment, and therefore an axis of rotation of the pivot portion 152 of the pivot bracket 150 and the axis of the second rotating shaft 142 are coaxial. Hence, during the rotation of the third body 130, the third body 130 rotates relative to the first body 110 or/and the second body 120 along the axis of the first rotating shaft 141 and the second rotating shaft 142. In other words, according to the present embodiment, the first body 110, the second body 120, and the third body 130 rotate coaxially relative to one another along the same axis.

Additionally, as shown in FIG. 6, FIG. 7A, and FIG. 7B, in the present embodiment, the hinge structure 140 optionally includes a first position-limiting ring sleeve 143 and a second position-limiting ring sleeve 145. According to the present embodiment, the first position-limiting ring sleeve 143 and the second position-limiting ring sleeve 145 are respectively sleeved on the first rotating shaft 141 and the second rotating shaft 142 of the hinge structure 140, so as to be moved together with the first rotating shaft 141 and the second rotating shaft 142. In the present embodiment, the first position-limiting ring sleeve 143 and the second position-limiting ring sleeve 145 together define a ring-shaped track 148, so as to allow the pivot portion 152 of the pivot bracket 150 to move along the ring-shaped track 148. More specifically, as shown in FIG. 7A and FIG. 7B, in the present embodiment, the pivot portion 152 of the pivot bracket 150 includes an arc-shaped bump 155, two trenches 153 and 154 at two sides of the arc-shaped bump 155, and a stopper 156 at the end of the arc-shaped bump 155. In the present embodiment, the two trenches 153 and 154 of the pivot portion 152 respectively correspond to the first position-limiting ring sleeve 143 and the second position-limiting ring sleeve 145, and may thus accommodate the first position-limiting ring sleeve 143 and the second position-limiting ring sleeve 145. The arc-shaped bump 155 of the pivot portion 152 extends into the ring-shaped track 148 and may thus move along the ring-shaped track 148.

As shown in FIG. 7A, according to the present embodiment, the hinge structure 140 further includes a first stopping surface 144 formed on the first position-limiting ring sleeve 143 and located on a rotational track of the stopper 156 of the pivot portion 152 of the pivot bracket 150 to limit a rotational range of the pivot bracket 150 relative to the hinge structure 140. More particularly, the first stopping surface 144 is located on the first position-limiting ring sleeve 143, the first position-limiting ring sleeve 143 is sleeved on the first rotating shaft 141, the first rotating shaft 141 is fixed to the first body 110, and the fixing portion 158 of the pivot bracket 150 is fixed to the third body 130; therefore, the first stopping surface 144 and the stopper 156 may together limit the rotational range of the third body 130 relative to the first body 110.

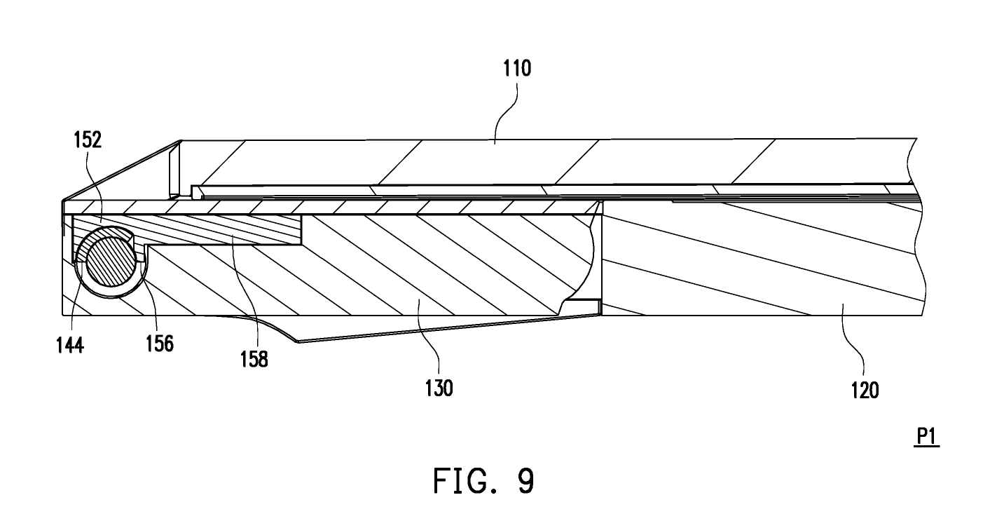

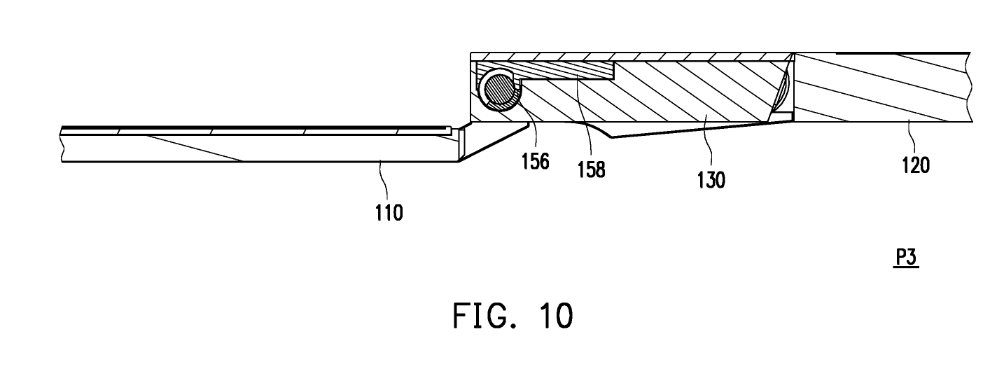

FIG. 9 is a schematic view illustrating a partial vertical cross-section of the electronic device depicted in FIG. 1 is at the closed position. FIG. 10 is a schematic view illustrating a partial vertical cross-section of the electronic device at the deployed position depicted in FIG. 3. Referring to FIG. 9 and FIG. 10, when the first body 110 relative to the second body 120 and the third body 130 is at the closed position P1 and the deployed position P3, respectively, the relative relationship between the first stopping surface 144 of the first position-limiting ring sleeve 143 and the stopper 156 of the pivot portion 152 may be observed in FIG. 9 and FIG. 10. As clearly shown in FIG. 9 and FIG. 10, when the first body 110 moves relative to the second body 120 and the third body 130 from the closed position P1 to the deployed position P3, the first position-limiting ring sleeve 143 rotates along with the first body 110 such that the first stopping surface 144 gradually approaches and turns to the stopper 156 of the pivot portion 152 until the first stopping surface 144 of the first position-limiting ring sleeve 143 contacts the stopper 156 of the pivot portion 152. As shown in FIG. 10 (i.e., at the deployed position P3), since the position of the pivot portion 152 of the pivot bracket 150 is limited by the first stopping surface 144 of the first position-limiting ring sleeve 143 fixed to the first rotating shaft 141, the third body 130 fixed to the fixing portion 158 of the pivot bracket 150 cannot rotate relative to the first body 110 fixed to the first rotating shaft 141. Hence, when the first body 110 continues to rotate relative to the second body 120 (i.e., as shown in FIG. 3 to FIG. 4 where the second body 120 rotates relative to the first body 110), the third body 130 maintains a relative position between the first body 110 and the third body 130, and does not rotate relative to the first body 110 as the second body 120 does.

That is to say, as shown in FIG. 9 and FIG. 10, in the present embodiment, when the first rotation angle (i.e., the included angle between the first body 110 and the second body 120) is less than 180 degrees, the stopper 156 does not contact the first stopping surface 144, so that the third body 130 is adapted to rotate relative to the first body 110. As shown in FIG. 10, FIG. 3, and FIG. 4, in this embodiment, when the first rotation angle (i.e., the included angle between the first body 110 and the second body 120) increases from 180 degrees to 270 degrees, the stopper 156 is in contact with the first stopping surface 144 to restrict the third body 130 from rotating relative to the first body 110, whereby the display module (the screen 113) and the speaker module (the speaker, the sound collection unit, or the like) are coplanar.

In other words, according to the present embodiment, owing to the position-limiting relationship between the first stopping surface 144 of the first position-limiting ring sleeve 143 and the stopper 156 of the pivot portion 152, the second rotation angle θ2 (shown in FIG. 4) at which the third body 130 is adapted to rotate relative to the first body 110 is provided. Besides, when the user unfolds the first body 110 to the deployed position P3, if the user continues to turn the first body 110, or if the user flips the second body 120 in a direction opposite to the direction in which the first body 110 is turned, the relative angle between the third body 130 and the first body 110 does not change.

Moreover, as shown in FIG. 7B, the hinge structure 140 provided in the present embodiment further includes a second stopping surface 146 formed on a second position-limiting ring sleeve 145. The second stopping surface 146 is also located on the rotational track of the pivot portion 152 of the pivot bracket 150. According to the present embodiment, the second position-limiting ring sleeve 145 is sleeved on the second rotating shaft 142, the second rotating shaft 142 is fixed to the second body 120, and the pivot bracket 150 is fixed to the third body 130; therefore, for the electronic device 100, owing to the position-limiting relationship between the second stopping surface 146 of the second position-limiting ring sleeve 145 and the stopper 156 of the pivot portion 152, the relative position between the second body 120 and the third body 130 may be limited. As shown in FIG. 1 to FIG. 3, the stopper 156 is in contact with the second stopping surface 146 (shown in FIG. 7B) to restrict the third body 130 from rotating relative to the second body 120, and the relative position between the second stopping surface 146 (shown in FIG. 7B) of the second position-limiting ring sleeve 145 and the stopper 156 of the pivot portion 152 does not change, whereby the speaker module and the input module 128 stay coplanar. Similarly, in the present embodiment, when the included angle between the first body 110 and the second body 120 decreases from 180 degrees to 0 degree, the stopper 156 is in contact with the second stopping surface 146 (shown in FIG. 7B) to restrict the third body 130 from rotating relative to the second body 120. Accordingly, in FIG. 1 to FIG. 3, when the included angle between the first body 110 and the second body 120 is less than 180 degrees, the third body 130 and the second body 120 do not rotate relative to each other, but the third body 130 rotates along with the second body 120. The third body 130 may rotate relative to the first body 110 but may not rotate together with the first body 110.

In FIG. 3 and FIG. 4, when the second body 120 rotates relative to the third body 130, the second stopping surface 146 (shown in FIG. 7B) of the second position-limiting ring sleeve 145 gradually approaches and turns to the stopper 156 of the pivot portion 156 until the second stopping surface 146 of the second position-limiting ring sleeve 145 contacts the stopper 156 of the pivot portion 152. The position of the second body 120 is thus limited, and the second body 120 is prevented from continuously rotating relative to the third body 130.

Hence, when the included angle between the first body 110 and the second body 120 is greater than 180 degrees, the stopper 156 is not in contact with the second stopping surface 146 (shown in FIG. 7B), and the third body 130 is allowed to rotate relative to the second body 120, as shown in FIG. 4. That is, in the process shown in FIG. 3 to FIG. 4, when the included angle between the first body 110 and the second body 120 is greater than 180 degrees, the third body 130 and the first body 110 do not rotate relative to each other, but the third body 130 may rotate along with the first body 110. The third body 130 may rotate relative to the second body 120 but may not rotate together with the second body 120. Similarly, returning to FIG. 3 from FIG. 4, while the included angle between the first body 110 and the second body 120 decreases from 270 degrees to 180 degrees, the stopper 156 keeps contacting the first stopping surface 144 to restrict the third body 130 from rotating relative to the first body 110.

In the present embodiment, the second rotation angle θ2 (shown in FIG. 4, i.e., the arrangement of the first stopping surface 144 of the first position-limiting ring sleeve 143 and the stopper 156 of the pivot portion 152) and the arrangement of the second stopping surface 146 of the second position-limiting ring sleeve 145 and the stopper 156 of the pivot portion 152 jointly contribute to the first rotation angle θ1 (shown in FIG. 4) at which the second body 120 is adapted to rotate relative to the first body 110. In the process shown in FIG. 1 to FIG. 3, the second rotation angle θ2 at which the second body 120 can rotate relative to the first body 110 is 180 degrees, for instance. In the process shown in FIG. 3 to FIG. 4, the first body 110 and the third body 130 do not rotate relative to each other, and the rotation angle (e.g., 90 degrees) at which the second body 120 can rotate relative to the third body 130 is the rotation angle at which the second body 120 can rotate relative to the first body 110. Therefore, in the present embodiment, the second body 120 may rotate by 270 degrees relative to the first body 110 and stand on the desktop together with the third body 130. It is worthy to note that in the present embodiment, the positions of the first stopping surface 144 and the second stopping surface 146 are respectively limited by the same stopper 156; however, in other embodiments, different stoppers may be applied to limit the positions of the first stopping surface 144 and the second stopping surface 146, which should not be construed as a limitation in the disclosure.

In other embodiments, note that the first stopping surface 144 and the second stopping surface 146 of the hinge structure 140 may also be integrally formed on the first rotating shaft 141 and the second rotating shaft 142 so that the first position-limiting ring sleeve and the second position-limiting ring sleeve are no longer required. Alternatively, in other embodiments, the first position-limiting ring sleeve may be sleeved on the second rotating shaft 142, and the second position-limiting ring sleeve may be sleeved on the first rotating shaft 141. In other alternative embodiments, the first stopping surface 144 or/and the second stopping surface 146 of the hinge structure 140 may be omitted, so that the pivot bracket 150 is no longer subject to the rotation angle of the first body 110 or/and the rotation angle of the second body 120. That is, as provided in such embodiments, the users may adjust the relative positions among the first body 110, the second body 120, and the third body 130 at their own discretion, which ensures flexibility of use of the electronic device.

To sum up, the electronic device is equipped with three bodies, so as to satisfy diverse needs of users. Besides, the electronic device provided herein is pivotally connected to the first body and the second body by the hinge structure, so as to adapt the second body to rotate relative to the first body. In addition, the pivot portion of the pivot bracket is pivoted to the hinge structure, and the third body is fixed to the fixing portion of the pivot bracket to adapt the third body to rotate relative to the first body. As such, the first body, the second body, and the third body may rotate relative to one another along the same axis, and the user may adjust the positions of the three bodies according to actual needs, so as to enhance the user's experience while the electronic device performs different functions.

It will be apparent to those skilled in the art that various modifications and variations can be made to the structure of the disclosure without departing from the scope or spirit of the disclosure. In view of the foregoing, it is intended that the disclosure cover modifications and variations provided they fall within the scope of the following claims and their equivalents.

What is claimed is:

1. An electronic device comprising:
a first body;
a second body;
a hinge structure pivotally connected to the first body and the second body to adapt the second body to rotate along an axis relative to the first body;
a pivot bracket comprising a pivot portion and a fixing portion, wherein the pivot portion is pivoted to the hinge structure; and
a third body fixed to the fixing portion of the pivot bracket to adapt the third body to rotate along the axis relative to the first body.

2. The electronic device as recited in claim 1, wherein the first body comprises a first surface and a second surface opposite to each other, the first body is adapted to be turned to a deployed position from a closed position at which the first surface of the first body abutting against the second body and the third body, wherein the second body comprises a first side away from the hinge structure, when the first body is located at the deployed position, the second body is adapted to be turned relative to the first body, such that the first side of the second body approaches the second surface of the first body, and the third body is adapted to maintain a relative position relative to the first body.

3. The electronic device as recited in claim 1, wherein a first rotation angle at which the second body is adapted to rotate relative to the first body is greater than a second rotation angle at which the third body is adapted to rotate relative to the first body.

4. The electronic device as recited in claim 3, wherein a maximum value of the first rotation angle is from 160 degrees to 290 degrees, and a maximum value of the second rotation angle is from 135 degrees to 200 degrees.

5. The electronic device as recited in claim 3, wherein a maximum value of the first rotation angle is from 160 degrees to 290 degrees, and a maximum value of the second rotation angle is from 0 degree to 135 degrees.

6. The electronic device as recited in claim 1, wherein when a third rotation angle is between the first body and the second body, and the third body and the second body are in an unfolded flat configuration, the electronic device is located at a first working position, wherein when the first body is in an unfolded flat configuration with respect to the second body and the third body, the electronic device is located at a deployed position, wherein when a first rotation angle is between the first body and the second body, and a second rotation angle is between the first body and the third body, the electronic device is located at a second working position, and when the first body is closed with the second body and the third body, the electronic device is located at a closed position.

7. The electronic device as recited in claim 1, wherein the hinge structure comprises a first stopping surface located on a rotational track of the pivot portion of the pivot bracket to limit a rotational range of the pivot bracket relative to the hinge structure.

8. The electronic device as recited in claim 7, wherein the hinge structure comprises a first rotating shaft, a second rotating shaft pivotally connected to the first rotating shaft, and a first position-limiting ring sleeve, the first rotating shaft is fixed to the first body, the second rotating shaft is fixed to the second body, the first position-limiting ring sleeve is sleeved on the first rotating shaft or the second rotating shaft, the pivot portion of the pivot bracket is pivoted to the first rotating shaft or the second rotating shaft sleeved by the first position-limiting ring sleeve, and the first stopping surface is formed on the first position-limiting ring sleeve.

9. The electronic device as recited in claim 8, wherein the hinge structure further comprises a second position-limiting ring sleeve, the first position-limiting ring sleeve is sleeved on one of the first rotating shaft and the second rotating shaft, the second position-limiting ring sleeve is sleeved on the other of the first rotating shaft and the second rotating shaft, a second stopping surface of the hinge structure is formed on the second position-limiting ring sleeve, and the second stopping surface is located on the rotational track of the pivot portion of the pivot bracket.

10. The electronic device as recited in claim 1, wherein the second body comprises a second side close to the hinge structure, the second body has a recess recessed into the second side, when the second body and the third body are in the same plane, the third body is located in the recess.

11. The electronic device as recited in claim 10, wherein an outer contour of the third body and an inner contour of the recess of the second body are conformal.

12. The electronic device as recited in claim 1, wherein the first body comprises a screen, the second body comprises an input module, and the third body comprises a speaker, a sound collection unit, or a sub-screen.

13. An electronic device comprising:
a first body comprising a display module;
a second body pivotally connected to the first body; and
a third body located between the first body and the second body, wherein when a first rotation angle is between the first body and the second body, a second rotation angle is between the first body and the third body, and the first rotation angle is greater than the second rotation angle, the second body and the third body together support the first body.

14. The electronic device as recited in claim 13, wherein the third body is pivotally connected to the first body or the second body.

15. The electronic device as recited in claim 14, wherein an axis of rotation between the first body and the second body and an axis of rotation between the third body and the first body or the second body are coaxial.

16. The electronic device as recited in claim 13, wherein when the first rotation angle is greater than 180 degrees, the third body rotates along with the first body without rotating with the second body.

17. The electronic device as recited in claim 13, wherein when the first rotation angle is less than 180 degrees, the third body rotates along with the second body without rotating with the first body.

18. The electronic device as recited in claim 13, wherein the third body is slidably disposed on the first body or the second body.

19. The electronic device as recited in claim 13, further comprising a hinge structure pivotally connected to the first body and the second body to adapt the second body to rotate along an axis relative to the first body; and
a pivot bracket comprising a pivot portion and a fixing portion, wherein the pivot portion is pivoted to the hinge structure.

20. The electronic device as recited in claim 19, wherein the hinge structure comprises a first stopping surface located on a rotational track of the pivot portion of the pivot bracket, so as to limit a rotational range of the pivot bracket relative to the hinge structure.

21. The electronic device as recited in claim 20, wherein the hinge structure comprises a first rotating shaft, a second rotating shaft pivotally connected to the first rotating shaft, and a first position-limiting ring sleeve, the first rotating shaft is fixed to the first body, the second rotating shaft is fixed to the second body, the first position-limiting ring sleeve is sleeved on the first rotating shaft or the second rotating shaft, the pivot portion of the pivot bracket is pivoted to the first rotating shaft or the second rotating shaft sleeved by the first position-limiting ring sleeve, and the first stopping surface is formed on the first position-limiting ring sleeve.

22. The electronic device as recited in claim 21, wherein the hinge structure comprises a second position-limiting ring sleeve, the first position-limiting ring sleeve is sleeved on one of the first rotating shaft and the second rotating shaft, the second position-limiting ring sleeve is sleeved on the other of the first rotating shaft and the second rotating shaft, a second stopping surface of the hinge structure is formed on the second position-limiting ring sleeve, and the second stopping surface is located on the rotational track of the pivot portion of the pivot bracket.

23. The electronic device as recited in claim 13, wherein the second body comprises a second side close to the hinge structure, the second body has a recess recessed into the second side, when the second body and the third body are in the same plane, the third body is located in the recess.

24. The electronic device as recited in claim 23, wherein an outer contour of the third body and an inner contour of the recess of the second body are conformal.

25. The electronic device as recited in claim 13, wherein the second body comprises an input module, and the third body comprises a speaker, a sound collection unit, or a sub-screen.
